(19) United States
(12) Patent Application Publication
(10) Pub. No.: US 2019/0129270 A1
(43) Pub. Date: May 2, 2019

(54) DISPLAY DEVICE

(71) Applicant: Japan Display Inc., Tokyo (JP)

(72) Inventors: Koji ISHIZAKI, Tokyo (JP); Yoshitaka OZEKI, Tokyo (JP); Takahiro TAKEUCHI, Tokyo (JP); Yasuhiro KANAYA, Tokyo (JP); Hirotaka HAYASHI, Tokyo (JP); Akihiro OGAWA, Tokyo (JP)

(73) Assignee: Japan Display Inc., Tokyo (JP)

(21) Appl. No.: 16/170,135

(22) Filed: Oct. 25, 2018

(30) Foreign Application Priority Data
Oct. 26, 2017 (JP) 2017-207571

(51) Int. Cl. G02F 1/167; G06F 3/044; G02F 1/1333; G02F 1/1343; G02F 1/1339

(52) U.S. Cl. CPC G02F 1/167; G06F 3/044; G02F 1/133345; G02F 1/134309; G02F 1/1368; G02F 1/13338; G02F 1/133308; G06F 2203/04111; G02F 2001/1676; G02F 1/1339

(57) ABSTRACT

According to one embodiment, a display device includes a first basement, an organic insulating film above the first basement and including a first upper surface and a first end portion, an inorganic insulating film provided from the first upper surface to the first basement and covering the first upper surface and the first end portion, pixel electrodes provided in the display portion, a common electrode provided to be opposed to the pixel electrodes, an electrophoretic element provided between the pixel electrodes and the common electrode, and a sealant provided on the inorganic insulating film and sealing at least the electrophoretic element.

### CROSS-REFERENCE TO RELATED APPLICATIONS

This application is based upon and claims the benefit of priority from Japanese Patent Application No. 2017-207571, filed Oct. 26, 2017, the entire contents of which are incorporated herein by reference.

### FIELD

Embodiments described herein relate generally to a display device.

### BACKGROUND

In one example, an electrophoretic display device, which holds an electrophoretic element, in which microcapsules are arranged, between an element substrate and a counter-substrate, is disclosed. In this type of electrophoretic display device, it is required to suppress corrosion of various wiring lines and various electrodes incorporated in the electrophoretic display device, which is caused by moisture.

### BRIEF DESCRIPTION OF THE DRAWINGS

FIG. 1 is a plan view showing a first configuration example of a display device DSP of the present embodiment.

FIG. 2 is a cross-sectional view of the display device DSP shown in FIG. 1 taken along line A-A′.

FIG. 3 is a plan view showing each of a basement 10, an insulating film 13, and an insulating film 14 of a first substrate SUB1.

FIG. 4 is a plan view showing a pixel PX of the display device DSP shown in FIG. 1.

FIG. 5 is a cross-sectional view of the pixel PX shown in FIG. 4 taken along line D-D′.

FIG. 6 is a cross-sectional view showing a first modification of the display device DSP.

FIG. 7 is a cross-sectional view showing a second modification of the display device DSP.

FIG. 8 is a cross-sectional view showing a third modification of the display device DSP.

FIG. 9 is a cross-sectional view showing a fourth modification of the display device DSP.

FIG. 10 is a plan view showing a fifth modification of the display device DSP.

FIG. 11 is a cross-sectional view of the display device DSP taken along line F-F′ of FIG. 10.

FIG. 12 is a cross-sectional view showing another modification of the display device DSP taken along line F-F′ of FIG. 10.

FIG. 13 is a cross-sectional view showing yet another modification of the display device DSP taken along line F-F′ of FIG. 10.

FIG. 14 is a plan view showing a second configuration example of the display device DSP of the present embodiment.

FIG. 15 is a cross-sectional view of the display device DSP shown in FIG. 14 taken along line H-H′.

FIG. 16 is a cross-sectional view showing a modification of the second configuration example.

FIG. 17 is a plan view of a sensor device 100 applicable to the present embodiment.

FIG. 18 is a cross-sectional view showing an example of the display device DSP comprising the sensor device 100 shown in FIG. 17.

FIG. 19 is a cross-sectional view showing a third configuration example of the display device DSP of the present embodiment.

FIG. 20 is a cross-sectional view showing a modification of the third configuration example.

### DETAILED DESCRIPTION

In general, according to one embodiment, a display device includes: a display portion; a non-display portion defining the display portion; a first basement provided over the display portion and the non-display portion; an organic insulating film provided over the display portion and the non-display portion above the first basement, and the organic insulating film including a first upper surface and a first end portion; an inorganic insulating film provided from the first upper surface to the first basement and covering the first upper surface and the first end portion in the non-display portion; a plurality of pixel electrodes provided in the display portion; a common electrode provided to be opposed to the plurality of the pixel electrodes; an electrophoretic element provided between the pixel electrodes and the common electrode; and a sealant provided on the inorganic insulating film in the non-display portion, and sealing at least the electrophoretic element.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, and the like of the respective parts are illustrated schematically in the drawings, rather than as an accurate representation of what is implemented, but such schematic illustration is merely exemplary, and in no way restricts the interpretation of the invention. In addition, in the specification and drawings, structural elements which function in the same or a similar manner to those described in connection with preceding drawings are denoted by like reference numbers, and detailed explanations of them that are considered redundant may be arbitrarily omitted.

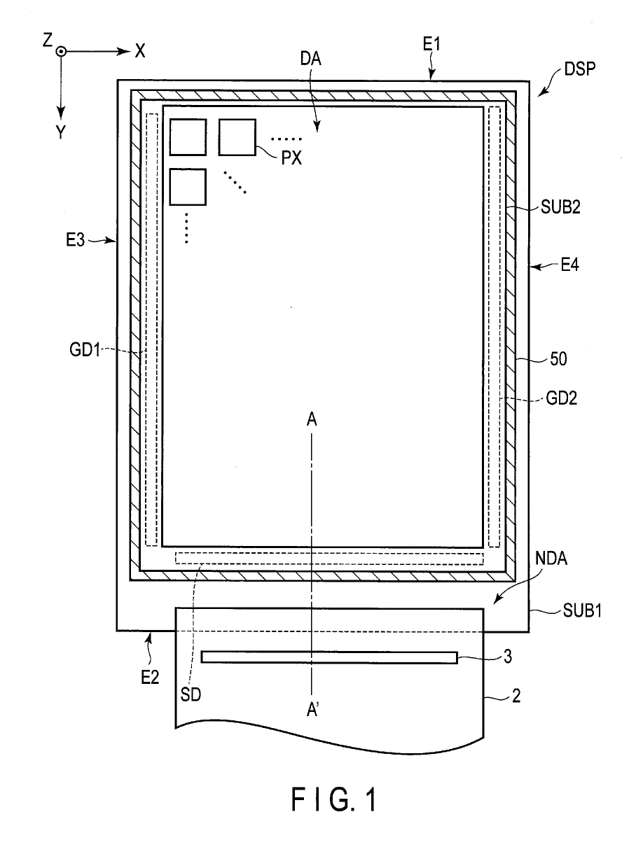

FIG. 1 is a plan view showing a first configuration example of a display device DSP of the present embodiment. In the drawing, a first direction X and a second direction Y intersect each other, and a third direction Z intersects the first direction X and the second direction Y. In one example, the first direction X, the second direction Y, and the third direction Z are orthogonal to each other, but may intersect at an angle other than 90 degrees. In the present specification, a direction toward a pointing end of an arrow indicating the third direction Z is referred to as upward (or merely above), and a direction toward the opposite side from the pointing end of the arrow is referred to as downward (or merely below). Further, it is assumed that an observation position at which the display device DSP is to be observed is at the pointing end side of the arrow indicating the third direction Z, and a view toward an X-Y plane defined by the first direction X and the second direction Y from this observation position is called a planar view.

The display device DSP comprises a first substrate SUB1, a second substrate SUB2, and a sealant 50. The display device DSP includes sides E1 and E2 extending along the first direction X, and sides E3 and E4 extending along the second direction Y. These sides E1 to E4 are included in the first substrate SUB1. The second substrate SUB2 is located on an inner side relative to the sides E1 to E4. The display device DSP includes a display portion DA in which an image is displayed, and a non-display portion NDA around the display portion DA. The non-display portion NDA is formed in a frame shape, and defines the display portion. The display portion DA is located in an area where the first substrate SUB1 overlaps the second substrate SUB2 in planar view. The display portion DA includes pixels PX arrayed in a matrix. Further, the display device DSP comprises gate drivers GD1 and GD2, and a source driver SD in the non-display portion NDA. In the example illustrated, the gate driver GD1 is located between the side E3 and the display portion DA, the gate driver GD2 is located between the side E4 and the display portion DA, and the source driver SD is located between the side E2 and the display portion DA. Note that in the example illustrated, the gate drivers GD1 and GD2, and the source driver SD are located in an area where the first substrate SUB1 overlaps the second substrate SUB2, but may be located in an area where the first substrate SUB1 do not overlap the second substrate SUB2.

A flexible printed circuit 2 comprises an IC chip 3. The flexible printed circuit 2 is mounted on the first substrate SUB1 between the side E2 and the display portion DA.

The sealant 50 is formed of epoxy resin, acrylic resin, or the like, having water resistance. The sealant 50 is mainly located around the second substrate SUB2, and is formed in a loop shape. The sealant 50 is in contact with each of the first substrate SUB1 and the second substrate SUB2. In the example illustrated, the sealant 50 is located between each one of the sides E1 to E4 and the second substrate SUB2 in planar view.

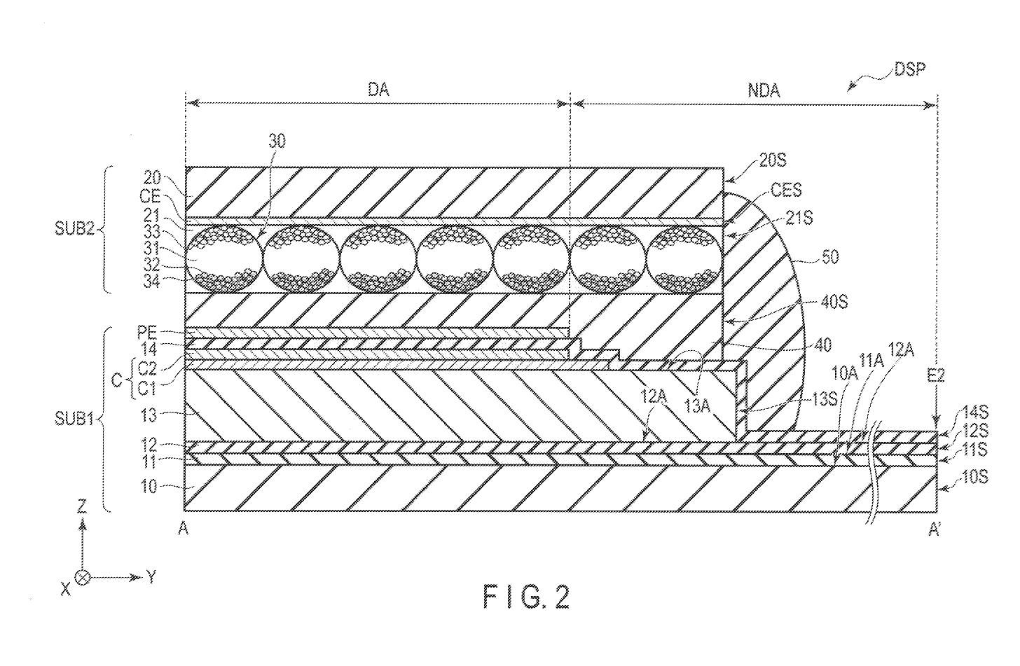

FIG. 2 is a cross-sectional view of the display device DSP shown in FIG. 1 taken along line A-A′. Note that in FIG. 2, circuits such as various drivers, and flexible printed circuits are omitted from the illustration. The first substrate SUB1 and the second substrate SUB2 are bonded together by an adhesive layer 40. In the illustrated cross section, it is assumed that the observation position of the display device DSP is above the second substrate SUB2 (i.e., in a normal direction of a surface of the second substrate SUB2).

The first substrate SUB1 comprises a basement 10, insulating films 11 to 14, a conductive layer C, and a pixel electrode PE. The insulating films 11 to 14 are all arranged over the display portion DA and the non-display portion NDA.

The basement 10 is formed of insulating glass or resin such as polyimide resin. Since the basement 10 is located on a side opposite to the observation position, the basement 10 may be opaque or transparent. The insulating film 11 is located on the basement 10, and includes an upper surface 11A and an end portion 11S. The insulating film 12 is located on the insulating film 11, and includes an upper surface 12A and an end portion 12S. The insulating films 11 and 12 extend to the side E2 of the first substrate SUB1, and the end portion 11S of the insulating film 11 and the end portion 12S of the insulating film 12 are both located above an end portion 10S of the basement 10. The insulating films 11 and 12 extend to each of the other sides E1, E3, and E4 of the first substrate SUB1, although this is not illustrated in the drawing.

The insulating film 13 is in contact with the upper surface 12A. The insulating film 13 includes an upper surface 13A and an end portion 13S. The end portion 13S is located in the non-display portion NDA. The insulating film 13 does not extend to the side E2. The end portion 13S is located on a side closer to the display portion DA than the side E2. Accordingly, the insulating films 11 and 12 are not overlapped by the insulating film 13 in a region between the end portion 13S and the side E2. Further, the end portion 13S protrudes more to the outer side than an end portion of the second substrate SUB2 (i.e., an end portion 20S of a basement 20). Similarly, the end portion 13S protrudes more to the outer side than an end portion 40S of the adhesive layer 40, or a microcapsule 30 on the outermost side.

The insulating film 14 includes an end portion 14S. The insulating film 14 covers each of the upper surface 13A and the end portion 13S, and extends to the upper surface 12A, in the non-display portion NDA. In the example illustrated, the insulating film 14 covers the upper surface 12A, and extends to the side E2. The end portion 14S is located above the end portion 12S. In the example illustrated, the insulating film 14 is directly in contact with each of the upper surface 13A, the end portion 13S, and the upper surface 12A.

As described above, in the present embodiment, the insulating film 14 also covers the end portion 13S of the insulating film 13, which protrudes more to the outer side than the end portion of the second substrate SUB2. As a result, the insulating film 14 also protrudes more to the outer side than the end portion of the second substrate SUB2. Similarly, the end portion 14S of the insulating film 14 protrudes more to the outer side than the end portion 40S of the adhesive layer 40, or the microcapsule 30 on the outermost side. Alternatively, it is possible to adopt a structure in which the end portion 13S and the end portion 14S do not protrude more outwardly than the end portion of the second substrate SUB2. Also, while the cross section of FIG. 2 shows a structure based on the lower side, i.e., the lower side E2, in FIG. 1, the arrangement of the insulating films 13 and 14 and the sealant 50 at the other sides, more specifically, the left side E3 and the right side E4, and the upper side E1, is the same as the structure in FIG. 2. As a matter of course, a display device in which the structure of FIG. 2 is applied to only one of the above sides is also adoptable.

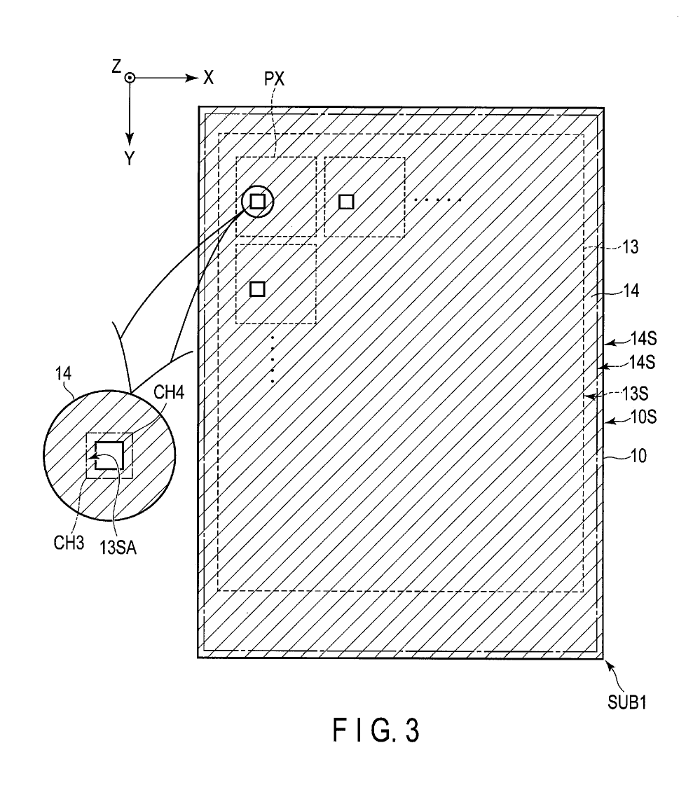

FIG. 3 is a plan view showing each of the basement 10, the insulating film 13, and the insulating film 14 of the first substrate SUB1. In the drawing, the insulating film 14 is represented by hatch lines, and the end portion 13S of the insulating film 13 is shown by a dotted line. The end portion 13S is entirely located on the inner side relative to the end portion 14S in planar view. In the example illustrated, the end portion 14S is flush with the end portion 10S of the basement 10. A portion between the end portion 10S and the end portion 13S is covered with the insulating film 14. Note that as shown by a one-dot chain line in the drawing, the end portion 14S may be located at a position which is on the outer side relative to the end portion 13S, and the inner side relative to the end portion 10S.

In each of the pixels PX, a portion where the insulating film 14 uncovers exists. Specifically, in an enlarged view of a portion indicated by a circle in FIG. 3, the insulating film 13 includes a contact hole CH3 indicated by a one-dot chain line in the drawing in each of the pixels PX. The insulating film 14 includes a contact hole CH4 indicated by a solid line in the figure in each of the pixels PX. The contact hole CH4 corresponds to a portion where the insulating film 14 uncovers. The contact hole CH4 is located on the inner side of the contact hole CH3 in planar view. That is, an end portion 13SA of the insulating film 13 in the contact hole CH3 is covered with the insulating film 14.

Explanation will be given referring to FIG. 2 again. The insulating film 11, the insulating film 12, and the insulating film 14 all correspond to an inorganic insulating film formed of an inorganic insulating material such as silicon oxide (SiO), silicon nitride (SiN), or silicon oxynitride (SiON). The insulating film 11, the insulating film 12, and the insulating film 14 may each have a single-layer structure or a laminated structure.

The insulating film 13 corresponds to an organic insulating film formed of an organic material such as acrylic resin. The insulating film 13 is formed to be thicker than any of the inorganic insulating films (the insulating film 11, the insulating film 12, and the insulating film 14). Further, the insulating film 13 is formed by applying or printing an organic material, and curing this organic material thereafter. Accordingly, the upper surface 13A of the insulating film 13 is formed to be substantially flat.

The conductive layer C is located on the upper surface 13A, and is covered with the insulating film 14. The conductive layer C includes a conductive layer C1 and a conductive layer C2. The conductive layer C1 is formed of a transparent conductive material such as indium tin oxide (ITO) or indium zinc oxide (IZO). The conductive layer C2 is formed of a metal material such as aluminum. As a specific example, the conductive layer C2 is formed of a stacked layer body of aluminum and titanium, or a stacked layer body of aluminum and molybdenum. In the example illustrated, although the conductive layer C2 is located on the conductive layer C1, the conductive layer C1 may be located on the conductive layer C2.

The pixel electrode PE is located on the insulating film 14 in the display portion DA. The pixel electrode PE is formed of a transparent conductive material such as ITO or IZO. The pixel electrode PE is opposed to the conductive layer C via the insulating film 14. The pixel electrode PE overlaps the conductive layer C via the insulating film 14, and forms a storage capacitance of the pixel PX. The insulating film 14 corresponds to a capacitive insulating film interposed between the conductive layer C and the pixel electrode PE.

The second substrate SUB2 comprises the basement 20, a common electrode CE, and an electrophoretic element 21. The basement 20 is formed of insulating glass or resin such as polyimide resin. Since the basement 20 is located on the observation position side, it is transparent. The common electrode CE is located between the basement 20 and the electrophoretic element 21. The common electrode CE is a transparent electrode formed of a transparent conductive material such as ITO or IZO. The electrophoretic element 21 is located between the pixel electrode PE and the common electrode CE. The electrophoretic element 21 is formed of microcapsules 30 arranged close to each other with almost no gap between the microcapsules 30 in the X-Y plane defined by the first direction X and the second direction Y.

The adhesive layer 40 is located between the pixel electrode PE and the electrophoretic element 21. The adhesive layer 40 is located between the insulating layer 14 and the electrophoretic element 21 in the non-display portion NDA.

An end portion CES of the common electrode CE, an end portion 21S of the electrophoretic element 21, and the end portion 40S of the adhesive layer 40 are located directly under the end portion 20S of the basement 20.

The sealant 50 is located in the non-display portion NDA, and seals the electrophoretic element 21. In the example illustrated, the sealant 50 seals not only the electrophoretic element 21, but also the adhesive layer 40. The sealant 50 is in contact with the insulating film 14. More specifically, the sealant 50 is directly in contact with the insulating film 14 covering the end portion 13S. As described above, although the end portion 13S protrudes more to the outer side than the second substrate SUB2, since the insulating film 14 is interposed between the sealant 50 and the upper surface 13A, and between the sealant 50 and the end portion 13S, the sealant 50 does not directly contact the insulating film 13. Also, the sealant 50 covers the adhesive layer 40 and a side portion (or an end portion 21S) of the electrophoretic element 21. In the example illustrated, the sealant 50 is directly in contact with each of the end portion 40S, the end portion 21S, the end portion CES, and the end portion 20S. While the insulating film 13 is located on the inner side relative to the sealant 50, the insulating film 14 is provided over an outside portion of the sealant 50.

The microcapsule 30 is a spherical body having a particle diameter of approximately 20 to 70 μm, for example. Although a number of microcapsules 30 are arranged between a single pixel electrode PE and the common electrode CE in reality, in the example illustrated, due to the constraints of a scale of the drawing, only a limited number of microcapsules 30 are illustrated. That is, in the pixel PX of a rectangular shape or a polygonal shape in which one side has a length of approximately one hundred to several hundreds of μm (micrometers), approximately one to ten microcapsules 30 are arranged.

The microcapsule 30 comprises a dispersion medium 31, black particles 32, and white particles 33. The black particles 32 and the white particles 33 may be referred to as electrophoretic particles. An outer shell portion (a wall film) 34 of the microcapsule 30 is formed by using a transparent resin such as acrylic resin, for example. The dispersion medium 31 is a liquid for dispersing the black particles 32 and the white particles 33 in the microcapsule 30. The black particle 32 is, for example, a particle (a high polymer or colloid) formed of black pigment such as aniline black, and is, for example, positively charged. The white particles 33 is, for example, a particle (a high polymer or colloid) formed of white pigment such as titanium dioxide, and is, for example, negatively charged. Various additives may be added to these kinds of pigment if necessary. Also, instead of the black particles 32 and the white particles 33, pigments whose colors are red, green, blue, yellow, cyan, magenta, and the like, may be used.

In the electrophoretic element 21 of the above structure, when the pixel PX is to perform black display, the pixel electrode PE is held at a relatively high potential than the common electrode CE. That is, when a potential of the common electrode CE is assumed as a reference potential, the pixel electrode PE is held in positive polarity. Consequently, while the positively charged black particles 32 are attracted to the common electrode CE, the negatively charged white particles 33 are attracted to the pixel electrode PE. As a result, when the pixel PX is observed from the common electrode CE side, the pixel PX is visually recognized as black. Meanwhile, in a case where the pixel PX is to perform white display, when a potential of the common electrode CE is assumed as the reference potential, the pixel electrode PE is held in negative polarity. Consequently, while the negatively charged white particles 33 are attracted to the common electrode CE side, the positively charged black particles 32 are attracted to the pixel electrode PE. As a result, when the pixel PX is observed, the pixel PX is visually recognized as white.

According to the present embodiment, the insulating film 14, which is the inorganic insulating film, covers the periphery of the insulating film 13, which is the organic insulating film. More specifically, the end portion 13S and the upper surface 13A, which constitute an edge portion of the periphery of the insulating film 13, are covered with the insulating film 14. An outer edge portion of the non-display portion NDA corresponding to the edge portion of the periphery of the organic insulating film may become a passage for entry of moisture into the display device DSP. In particular, rapidity of osmosis of moisture of the organic insulating film is greater than that of the inorganic insulating film, and it is desired to keep the organic insulating film away from moisture as much as possible.

In the present embodiment, while the end portion of the organic insulating film is positioned at a place corresponding to a passage for entry of moisture, the end portion is covered with the inorganic insulating film. As compared to the organic insulating film, the inorganic insulating film has such characteristics that water absorbency is low, an initial moisture content is low, and a moisture discharge amount is small. Furthermore, the rapidity of osmosis of moisture of the inorganic insulating film is remarkably smaller than that of the organic insulating film. Accordingly, entry of moisture from the end portion of the display device DSP through the insulating film 13 is suppressed. Also, undesired generation of ions caused by the entry of moisture is suppressed. Consequently, corrosion, which is caused by moisture, of various wiring lines and various electrodes that are incorporated in the display device DSP, or degradation of the electrophoretic element 21 is suppressed. As a result, reliability of a panel is improved.

Also, the sealant 50 is in contact with the insulating film 14, and moreover, covers the end portion 40S of the adhesive layer 40, and the end portion 21S of the electrophoretic element 21. As the sealant 50 is in close contact with the insulating film 14, a moisture passage at an interface between the sealant 50 and the insulating film 14 can be blocked. Further, a moisture passage at an interface between the insulating film 14 and the adhesive layer 40, and a moisture passage at an interface between the adhesive layer 40 and the electrophoretic element 21 are also blocked. Furthermore, entry of moisture from the end portion 40S and the end portion 21S is also suppressed.

Further, at an outer side relative to the insulating film 13 (i.e., a side away from the display portion DA), the insulating films 12 and 14 contact each other. The insulating films 12 and 14 are both inorganic insulating films, and are in close contact with each other. Accordingly, a moisture passage at an interface between the insulating films 12 and 14 can be blocked.

In addition, the insulating film 13 is sealed doubly by the insulating film 14 and the sealant 50. Accordingly, as compared to a case of sealing the insulating film 13 with only the sealant 50, the sealing capability can be improved.

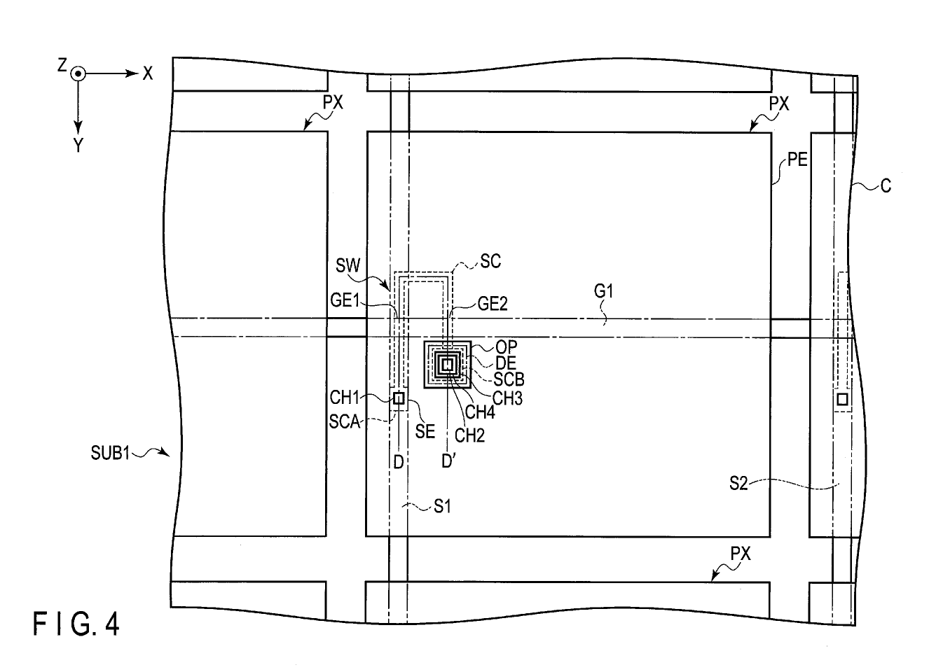

FIG. 4 is a plan view showing the pixel PX of the display device DSP shown in FIG. 1. Here, of the pixel PX, only the main elements of the first substrate SUB1 shown in FIG. 1 are depicted. In FIG. 4, a semiconductor layer SC is shown by a dotted line, a scanning line G is shown by a one-dot chain line, a signal line S is shown by a two-dot chain line, and a pixel electrode PE is shown by a solid line. Note that the conductive layer C is omitted from illustration, and only an opening portion OP provided in the conductive layer C is illustrated.

The pixel PX comprises a switching element SW, the conductive layer C, and the pixel electrode PE. The switching element SW comprises gate electrodes GE1 and GE2, the semiconductor layer SC, a source electrode SE, and a drain electrode DE. Although the illustrated switching element SW has a double-gate structure, it may have a single-gate structure. Further, the switching element SW may have a top-gate structure in which the gate electrodes GE1 and GE2 are arranged above the semiconductor layer SC, or may have a bottom-gate structure in which the gate electrodes GE1 and GE2 are arranged below the semiconductor layer SC.

The semiconductor layer SC is electrically connected to a signal line S1 through a contact hole CH1 at an end portion SCA of the semiconductor layer SC, and is electrically connected to the drain electrode DE through a contact hole CH2 at the other end portion SCB of the semiconductor layer SC. The semiconductor layer SC intersects a scanning line G1 between the end portion SCA and the other end portion SCB.

The gate electrodes GE1 and GE2 correspond to regions overlapping the semiconductor layer SC of the scanning line G1. In the example illustrated, the scanning line G1 extends along the first direction X, and crosses a central portion of the pixel PX. The source electrode SE includes a region in contact with the semiconductor layer SC of the signal line S1. In the example illustrated, the signal line S1 extends along the second direction Y, and is located on a left end portion of the pixel PX. The drain electrode DE is formed in an island shape, and is disposed between the signal lines S1 and S2.

The conductive layer C overlaps the pixels PX arranged in the first direction X and the second direction Y, and overlaps both of the scanning line G1 and the signal line S1. The conductive layer C includes the opening OP at a position overlapping the drain electrode DE in each of the pixels PX. The conductive layer C is formed over substantially the entire region of the display portion DA shown in FIG. 1. A common potential is supplied to the conductive layer C in the non-display portion NDA, for example.

The pixel electrode PE overlaps the conductive layer C, the switching element SW, the scanning line G1, and the signal line S1, in the pixel PX. The pixel electrode PE is electrically connected to the drain electrode DE through the contact holes CH3 and CH4, and the opening portion OP. In the example illustrated, the pixel electrode PE is formed in a square shape in which a length along the first direction X and a length along the second direction Y are equal to each other. However, the shape is not limited to this example. The pixel electrode PE may be formed in a rectangular shape extended to the first direction X or the second direction Y, or may be formed in the other polygonal shape.

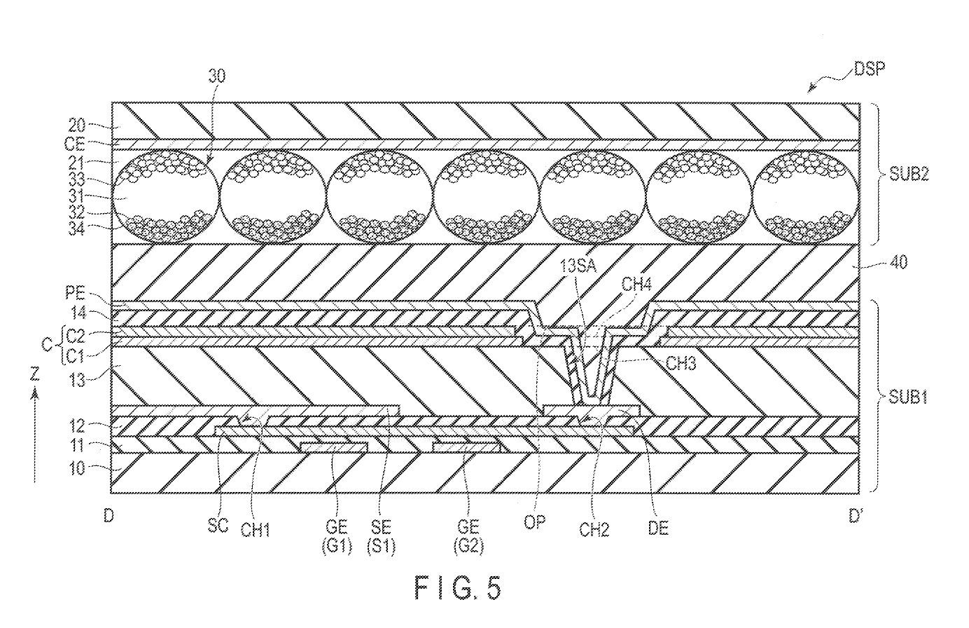

FIG. 5 is a cross-sectional view of the pixel PX shown in FIG. 4 taken along line D-D′. The gate electrodes GE1 and GE2, which are integral with the scanning line G1, are located on the basement 10, and are covered with the insulating film 11. The scanning line G1, and the gate electrodes GE1 and GE2 are formed of a metal material such as aluminum (Al), titanium (Ti), silver (Ag), molybdenum (Mo), tungsten (W), copper (Cu), or chromium (Cr), or an alloy obtained by combining the aforementioned metal materials, and may have a single-layer structure or a laminated structure.

The semiconductor layer SC is located on the insulating film 11, and is covered with the insulating film 12. While the semiconductor layer SC is formed of, for example, polycrystalline silicon (for example, low-temperature polysilicon), it may be formed of amorphous silicon or an oxide semiconductor. The source electrode SE integral with the signal line S1, and the drain electrode DE are located on the insulating film 12, and are covered with the insulating film 13.

The signal line S1, the source electrode SE, and the drain electrode DE are formed of the same material, and are formed by, for example, using the above-mentioned metal material. The source electrode SE is in contact with the semiconductor layer SC through the contact hole CH1 penetrating the insulating film 12. The drain electrode DE is in contact with the semiconductor layer SC through the contact hole CH2 penetrating the insulating film 12.

The conductive layer C functions as both a reflective film which reflects light entering from the second substrate SUB2 side, and a light-shielding film which blocks light traveling toward the switching element SW from the second substrate SUB2 side, for example.

The pixel electrode PE is in contact with the drain electrode DE through the contact hole CH3 penetrating the insulating film 13, and the contact hole CH4 penetrating the insulating film 14 at a position overlapping the opening portion OP.

Next, some modifications will be explained. In each of the modifications, a cross section near the side E2 of the display device DSP will be focused in the explanation. However, in the display device DSP of each of the modifications, not only the side E2, but also portions near the other sides E1, E3, and E4 have a similar structure of an end portion.

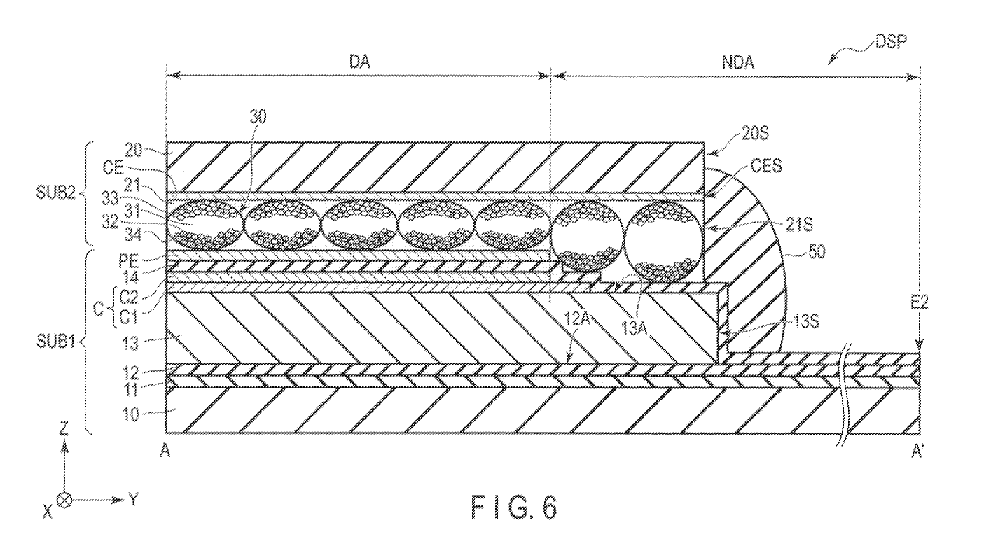

FIG. 6 is a cross-sectional view showing a first modification of the display device DSP. The first modification shown in FIG. 6 is different from the first configuration example shown in FIG. 2 in that the adhesive layer 40 is omitted. In the display portion DA, the electrophoretic element 21 is located between the pixel electrode PE and the common electrode CE. In the non-display portion NDA, the electrophoretic element 21 is located between the insulating film 14 and the common electrode CE (or the basement 20). The sealant 50 is in contact with the insulating film 14, and covers each of the end portion 21S, the end portion CES, and the end portion 20S.

Also in this first modification, advantages similar to those described above can be obtained. In addition, the display device DSP is made slim. Further, since an adhesive layer between the electrophoretic element 21 and the pixel electrode PE is omitted, the pixel electrode PE comes close to the electrophoretic element 21, and an electric field is easily applied to the electrophoretic element 21. Accordingly, the electrophoretic element 21 can be driven at a low voltage.

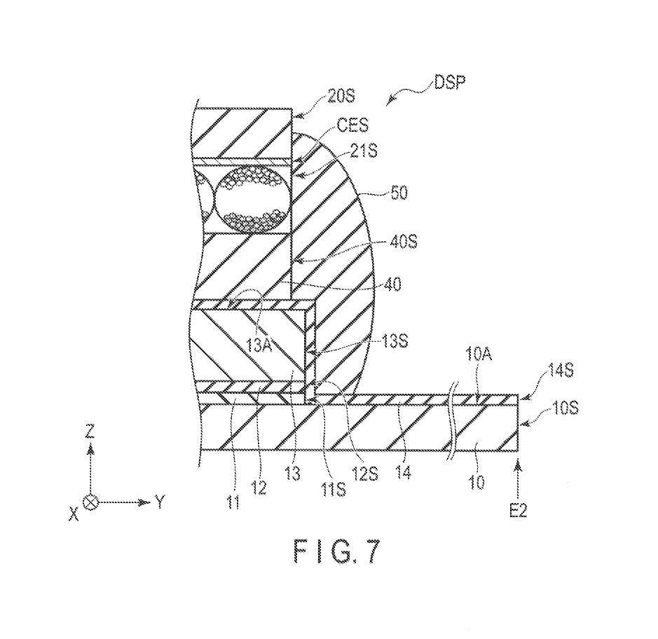

FIG. 7 is a cross-sectional view showing a second modification of the display device DSP. The second modification is different from the first configuration example shown in FIG. 2 in that the insulating films 11 and 12 do not extend to the side E2. The end portion 13S is located above the end portions 11S and 12S. The insulating film 14 covers each of the upper surface 13A and the end portion 13S, the end portion 12S, and the end portion 11S, and extends to an upper surface 10A of the basement 10. In the example illustrated, the insulating film 14 extends to the side E2, and covers the upper surface 10A located on the outer side relative to the end portion 11S. The end portion 14S is located above the end portion 10S.

Note that the end portions 11S and 12S do not need to overlap the end portion 13S. For example, when the position of each of the end portion 11S, the end portion 12S, the end portion 13S, and the side E2 in the second direction Y is noted, the end portions 11S and 12S may be located on the inner side relative to the end portion 13S. In such a case, the end portions 11S and 12S are covered with the insulating film 13. In this case, the insulating film 14 covers each of the upper surface 13A, the end portion 13S, and the upper surface 10A, without being in contact with the end portions 11S and 12S. Further, a case where the end portions 11S and 12S are located between the end portion 13S and the side E2 will be explained in a third modification below.

Also in this second modification, advantages similar to those described above can be obtained. In addition, an interface between the basement 10 and the insulating film 11, and an interface between the insulating film 12 and the insulating film 13, which may become passages for entry of moisture, are blocked by the insulating film 14. Accordingly, entry of moisture into the display device DSP is further suppressed.

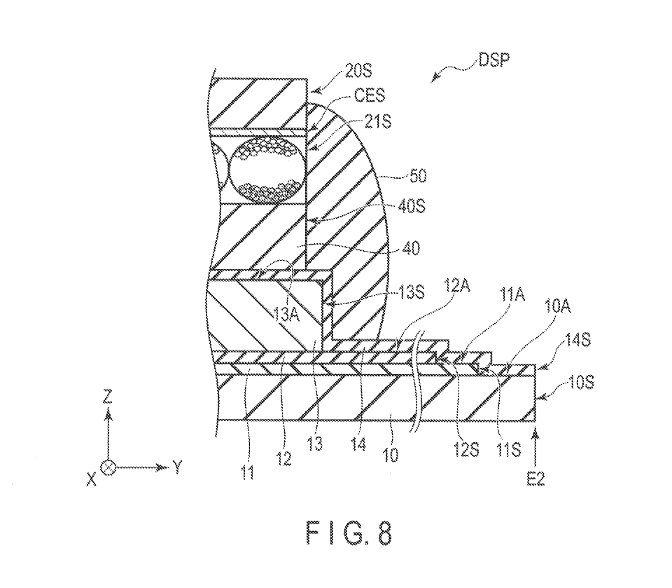

FIG. 8 is a cross-sectional view showing a third modification of the display device DSP. The third modification is different from the first configuration example shown in FIG. 2 in that the insulating films 11 and 12 are provided on the outer side relative to the insulating film 13, but do not extend to the side E2. The end portions 11S and 12S are located between the end portion 13S and the end portion 10S. Further, the end portion 11S is located between the end portion 12S and the end portion 10S. The end portion 12S is located between the end portion 13S and the end portion 11S. The insulating film 14 covers each of the upper surface 13A and the end portion 13S, the upper surface 12A and the end portion 12S that are located on the outer side relative to the end portion 13S, and the upper surface 11A and the end portion 11S that are located on the outer side relative to the end portion 12S, and extends to the upper surface 10A. In the example illustrated, the insulating film 14 extends to the side E2, and covers the upper surface 10A located on the outer side relative to the end portion 11S. The end portion 14S is located above the end portion 10S.

When the position of each of the end portion 11S, the end portion 12S, and the end portion 13S in the second direction Y is noted, the end portion 11S may be located between the end portion 12S and the end portion 13S. In this case, the end portion 11S is covered with the insulating film 12. In such a case, the insulating film 14 covers each of the upper surface 13A, the end portion 13S, the upper surface 12A, the end portion 12S, and the upper surface 10A, without being in contact with the upper surface 11A and the end portion 11S.

Also in this third modification, advantages similar to those of the second modification can be obtained.

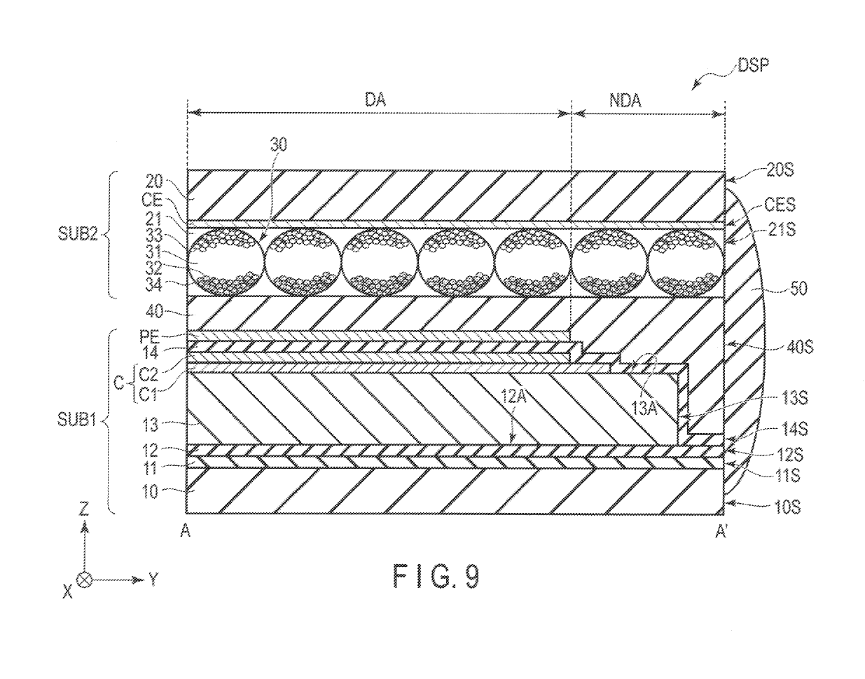

FIG. 9 is a cross-sectional view showing a fourth modification of the display device DSP. The end portion 10S of the basement 10 is located directly under the end portion 20S. The end portion 13S is located closer to the display portion DA than the end portion 10S and the end portion 20S. Each of the end portion 11S, the end portion 12S, and the end portion 14S is located directly above the end portion 10S. The sealant 50 covers each of the end portion 11S, the end portion 12S, and the end portion 14S. Also, the sealant 50 is in contact with at least a part of the end portion 10S.

According to the fourth modification described above, in addition to the above-described advantage, a narrower frame structure can be achieved for the display device DSP, since not only the side E2, but also portions near the other sides E1, E3, and E4 have a similar structure of an end portion.

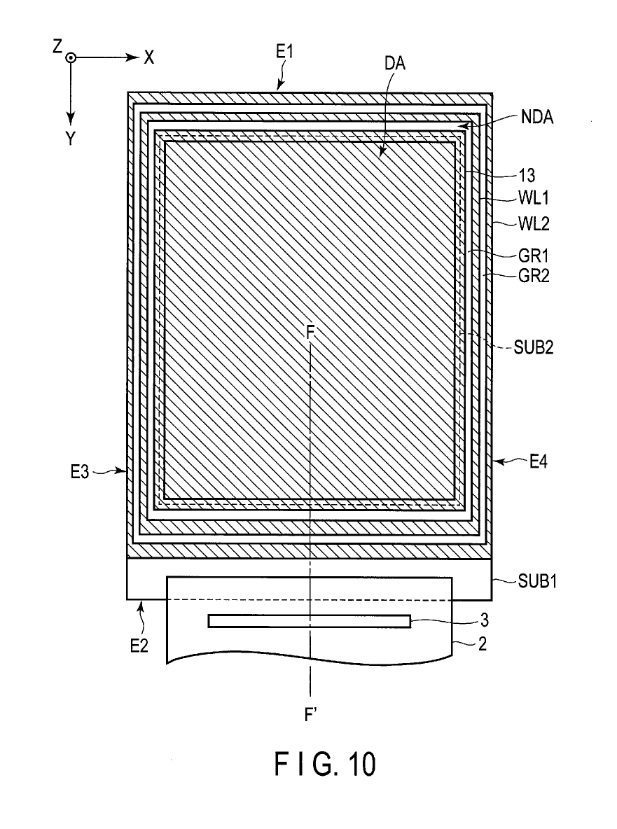

FIG. 10 is a plan view showing a fifth modification of the display device DSP. In this figure, of the elements of the first substrate SUB1, the insulating film 13 and a wall WL are illustrated. The second substrate SUB2 is shown by a dotted line in the figure. The fifth modification illustrated in FIG. 10 is different from the first configuration example shown in FIG. 2 in that the first substrate SUB1 comprises one or more walls WL opposed to the insulating film 13 through space GR. In the example illustrated, two walls WL1 and WL2 are provided. A wall WL1 is located on the outer side relative to the insulating film 13, and is away from the insulating film 13 through space GR1. A wall WL2 is located on the outer side relative to the wall WL1, and is away from the wall WL1 through space GR2. The spaces GR1 and GR2 are both located in the non-display portion NDA. In the example illustrated, the spaces GR1 and GR2 are formed in a loop shape. While the walls WL1 and WL2 may be formed of the same material as that of the insulating film 13, they may be formed of a material different from that of the insulating film 13.

A flexible printed circuit 2 comprising the IC chip 3 is mounted on the first substrate SUB1 between the wall WL2 and the side E2.

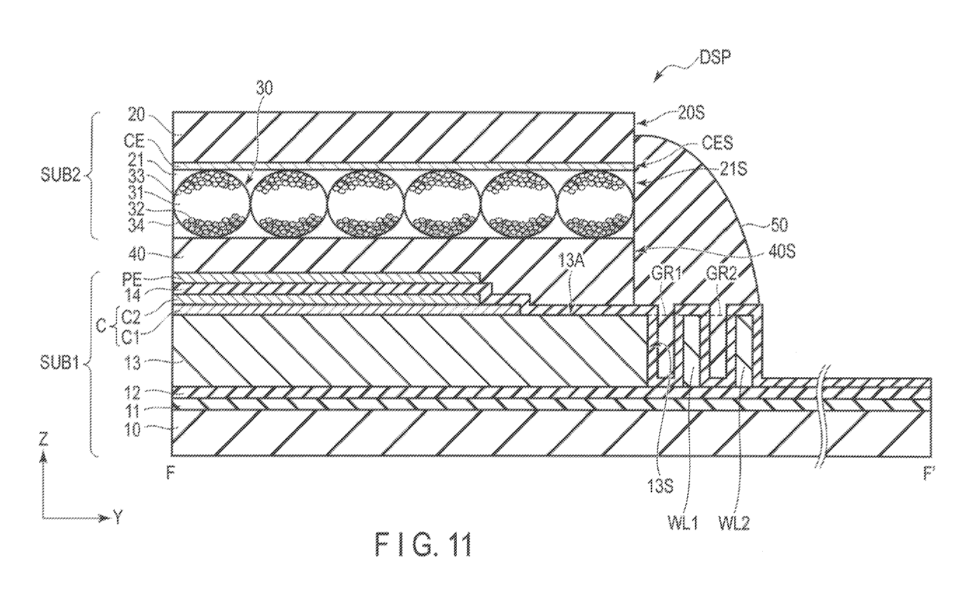

Although the sealant 50 is omitted from illustration, in planar view, the sealant 50 is located between the second substrate SUB2 and each side of the sides E1 to E4. In one example, the sealant 50 overlaps at least a part of the spaces GR1 and GR2 over the entire periphery. This point will be explained with reference to the cross-sectional view of FIG. 11.

FIG. 11 is a cross-sectional view of the display device DSP taken along line F-F′ of FIG. 10. The insulating film 14 covers at least the insulating film 13. In the example illustrated, the insulating film 14 covers each of the insulating film 13, and the walls WL1 and WL2. Also, in the spaces GR1 and GR2, the insulating film 14 is in contact with the insulating film 12. The sealant 50 is provided over the walls WL1 and WL2 from the insulating film 13, and is filled in the spaces GR1 and GR2.

According to the fifth modification described above, the insulating film 13, which is an organic insulating film, is away from the wall WL positioned on the outer side through the space GR. Also, in at least one space GR, the insulating film 14 covers the insulating film 13, and also contacts one of the insulating films 11 and 12 located below the insulating film 13, or contacts the basement 10. In this way, entry of moisture through the insulating film 13 can be suppressed. In addition, an area of contact between the insulating film 14 and the sealant 50 is increased, and adherence between the two can be improved. Also, when the sealant 50 is applied, spreading of the sealant 50 can be suppressed.

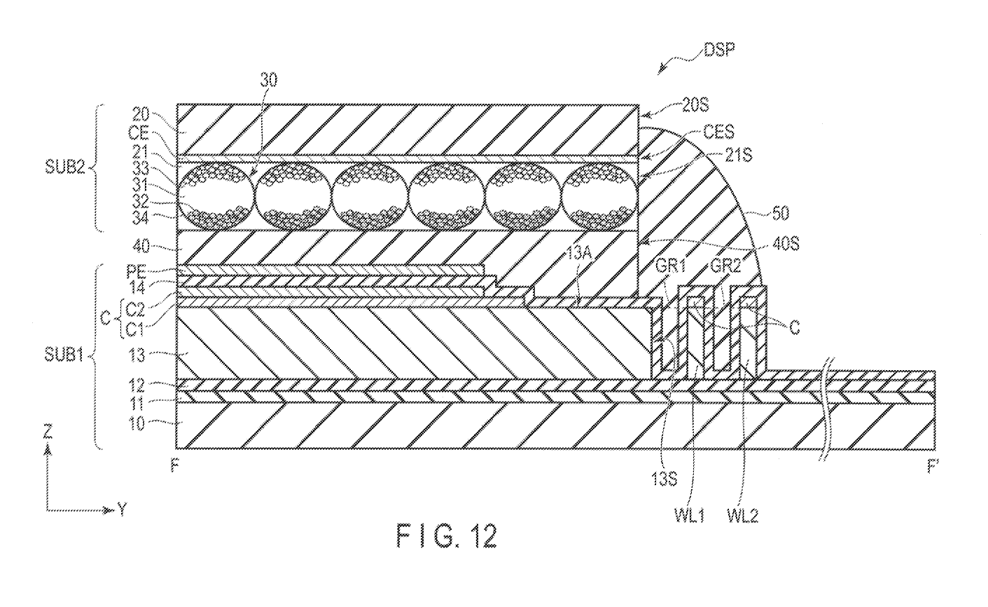

FIG. 12 is a cross-sectional view showing another modification of the display device DSP taken along line F-F′ of FIG. 10. The example illustrated in FIG. 12 is different from the example shown in FIG. 11 in that the conductive layer C overlaps the walls WL1 and WL2. Note that as the conductive layer C which overlaps the walls WL1 and WL2, one of the conductive layers C1 and C2 may be stacked or both of the conductive layers C1 and C2 may be stacked.

Consequently, a depth of the spaces GR1 and GR2 is increased, and when the sealant 50 is filled in the spaces GR1 and GR2, not only the area of contact between the insulating film 14 and the sealant 50 is increased, but also the spreading of the sealant 50 is suppressed.

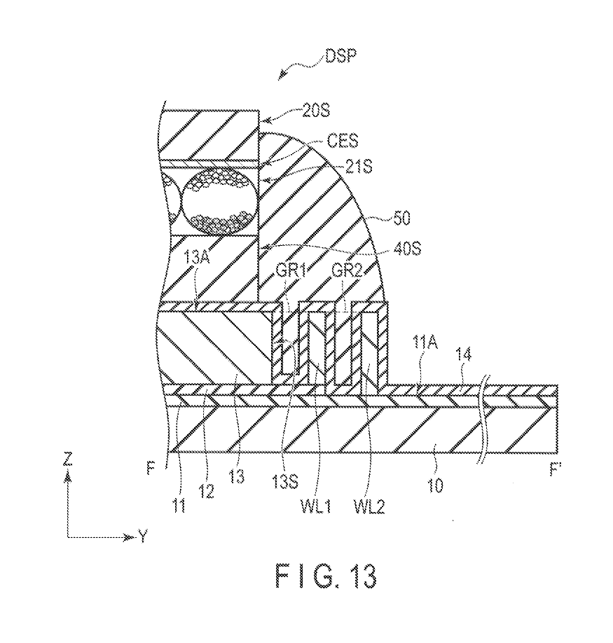

FIG. 13 is a cross-sectional view showing yet another modification of the display device DSP taken along line F-F′ of FIG. 10. The example shown in FIG. 13 is different from the example shown in FIG. 11 in that the insulating film 12 does not exist directly under the space GR2 and the wall WL2. In the space GR2, the insulating film 14 is in contact with the insulating film 11. The wall WL2 is in contact with the insulating film 11. Consequently, a depth of the space GR2 is increased, and an advantage similar to that of the example shown in FIG. 12 can be obtained.

At one of the spaces GR1 and GR2, or both of the spaces GR1 and GR2, the insulating film 14 may be in contact with the basement 10 or the insulating film 11. Also, one of the walls WL1 and WL2, or both of the walls WL1 and WL2 may be in contact with the basement 10 or the insulating film 11.

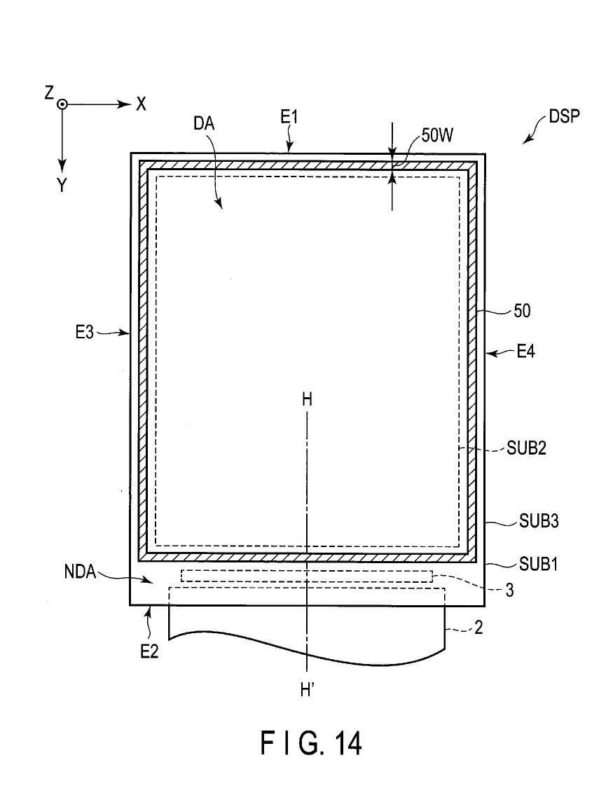

FIG. 14 is a plan view showing a second configuration example of the display device DSP of the present embodiment. The second configuration example shown in FIG. 14 is different from the first configuration example shown in FIG. 1 in that the display device DSP includes a third substrate SUB3 as a protective substrate. In planar view, the third substrate SUB3 is greater than the second substrate SUB2, and has a size which is equal to the size of the first substrate SUB1, or greater than the size of the first substrate SUB1. The third substrate SUB3 is located above the second substrate SUB2, and overlaps the first substrate SUB1 on the outer side of the second substrate SUB2. The sealant 50 seals a gap between the first substrate SUB1 and the third substrate SUB3 on the outer side of the second substrate SUB2. The sealant 50 has a uniform seal width 50W. In the example illustrated, although the sealant 50 is not in contact with the second substrate SUB2, the sealant 50 may contact the second substrate SUB2.

The flexible printed circuit 2 is mounted on the first substrate SUB1 between the display portion DA and the side E2. The IC chip 3 is mounted on the first substrate SUB1 between the display portion DA and the flexible printed circuit 2. In the example illustrated, as shown by a dotted line in the figure, a mounting portion of the flexible printed circuit 2 and the IC chip 3 are located between the first substrate SUB1 and the third substrate SUB3.

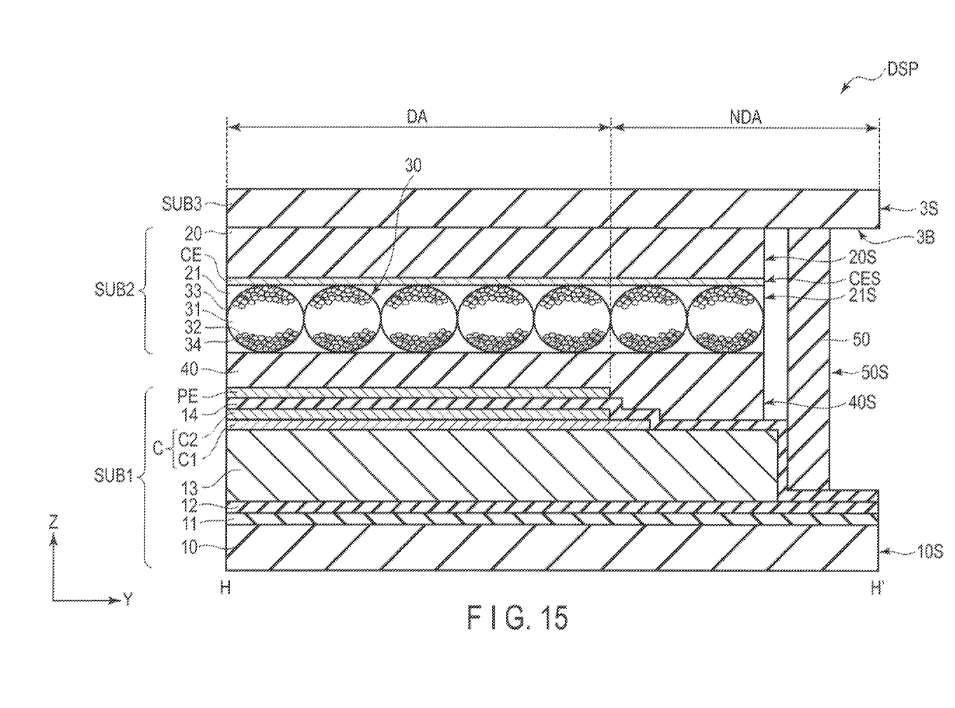

FIG. 15 is a cross-sectional view of the display device DSP shown in FIG. 14 taken along line H-H′. The third substrate SUB3 is a glass substrate, for example, and is bonded to the basement 20. The third substrate SUB3 includes a lower surface 3B opposed to the insulating film 14, and an end portion 3S in the non-display portion NDA. Since the third substrate SUB3 is located at the observation position side of the second substrate SUB2, the third substrate SUB3 is transparent at least in the display portion DA. The end portion 3S is located on the outer side relative to the end portion 20S. In the example illustrated, the end portion 3S is located directly above the end portion 10S. Note that the third substrate SUB3 may have a structure in which a barrier film, which is formed of an inorganic insulating film, is provided on a lower surface of a resin substrate, which is made of polyethylene terephthalate (PET) or the like.

The sealant 50 is in contact with each of the lower surface 3B and the insulating film 14. In the example illustrated, although the sealant 50 is not in contact with the second substrate SUB2 or the adhesive layer 40, the sealant 50 may be in contact with the second substrate SUB2 or the adhesive layer 40. The sealant 50 does not protrude to the outer side relative to the end portion 3S (i.e., a side away from the display portion DA), and is not in contact with the end portion 3S. In other words, an outer end portion 50S of the sealant 50 is located on the inner side relative to the end portion 3S (i.e., a side close to the display portion DA).

The display device DSP as described above can be obtained by applying the sealant 50 on the insulating film 14 after bonding the first substrate SUB1 and the second substrate SUB2 together by the adhesive layer 40, bonding the third substrate SUB3 to the second substrate SUB2, and then curing the sealant 50.

As the sealant 50 suitable in the second configuration example, a material obtained by mixing a filler, such as silica for maintaining a gap to be even, into an epoxy- or acrylic-based resin can be used. Also, from the standpoint of suppressing spreading of the sealant 50 after it has been applied, preferably, the sealant 50 should be a material having the viscosity of 20,000 mPa·s to 500,000 mPa·s in an uncured state.

According to the second configuration example, as compared to a case of applying the sealant 50 after bonding the third substrate SUB3 to the second substrate SUB2, the sealant 50 of high viscosity can be applied. Accordingly, spreading of the sealant 50 can be suppressed, and the seal width 50W can be reduced. Thus, a width of the non-display portion NDA can be reduced.

Also, since the third substrate SUB3 is bonded to the second substrate SUB2, as compared to a case where an air layer exists between the second substrate SUB2 and the third substrate SUB3, reflection or refraction at the interface can be suppressed, and visibility can be improved.

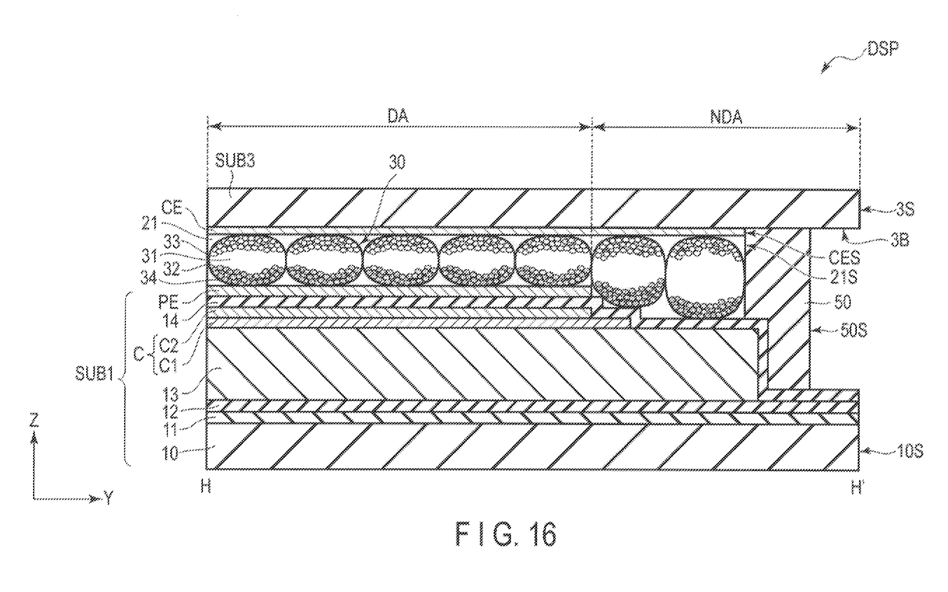

FIG. 16 is a cross-sectional view showing a modification of the second configuration example. The modification shown in FIG. 16 is different from the second configuration example shown in FIG. 15 in that the basement 20 and the adhesive layer 40 are omitted. The common electrode CE is provided on the lower surface 3B of the third substrate SUB3. The electrophoretic element 21 is held between the pixel electrode PE and the common electrode CE in the display portion DA. In the non-display portion NDA, the electrophoretic element 21 is located between the insulating film 14 and the common electrode CE (or the third substrate SUB3). The sealant 50 seals the electrophoretic element 21, and is in contact with each of the third substrate SUB3 and the insulating film 14.

Also in this modification, advantages similar to those described above can be obtained. In addition, the display device DSP is made slim. Further, the pixel electrode PE comes close to the electrophoretic element 21, and an electric field is easily applied to the electrophoretic element 21.

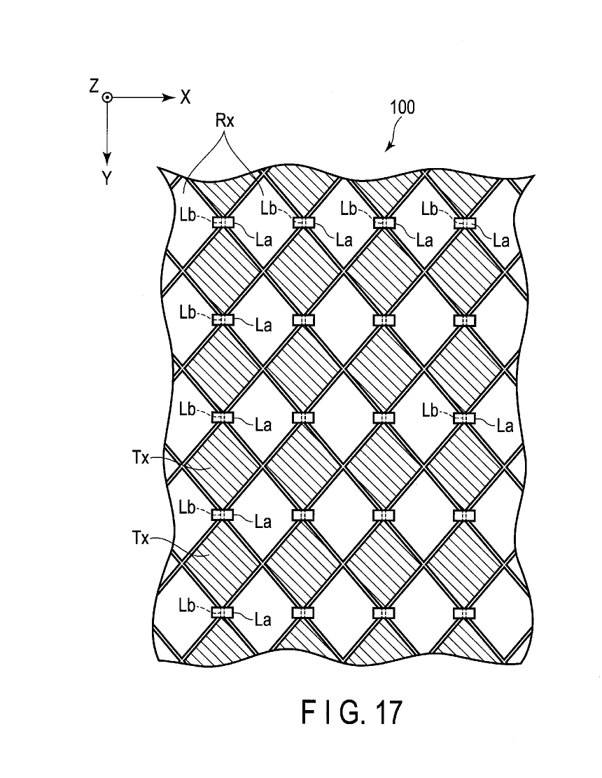

FIG. 17 is a plan view of a sensor device 100 applicable to the present embodiment. Here, as the sensor device 100, a capacitive type device will be explained. The sensor device 100 comprises a plurality of detection electrodes Rx, and a plurality of drive electrodes Tx. The detection electrodes Rx and the drive electrodes Tx are formed of a transparent conductive material such as ITO. The detection electrodes Rx arranged in the first direction X are electrically connected to each other by a first connection line La. The drive electrodes Tx arranged in the second direction Y are electrically connected to each other by a second connection line Lb. The first connection line La and the second connection line Lb cross each other in planar view.

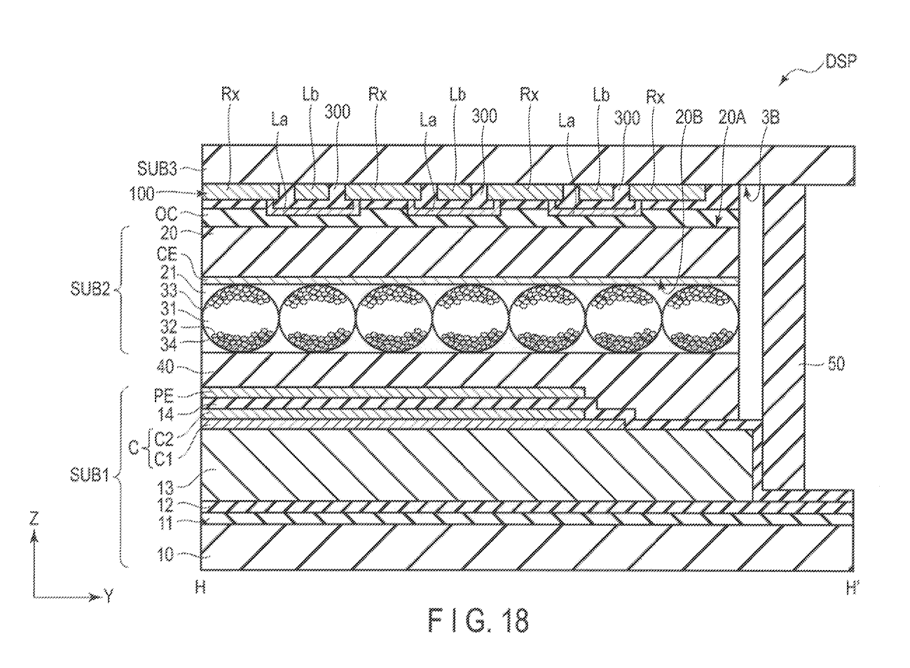

FIG. 18 is a cross-sectional view showing an example of the display device DSP comprising the sensor device 100 shown in FIG. 17. The cross-sectional view shown in FIG. 18 corresponds to the cross-sectional view of the display device DSP shown in FIG. 14 taken along line H-H′. The sensor device 100 is provided between the third substrate SUB3 and the common electrode CE. In the example illustrated, while the sensor device 100 is formed on the lower surface 3B, the sensor device 100 may be formed on an upper surface 20A or a lower surface 20B of the basement 20. Also, the sensor device 100 may be one which is formed on a substrate different from the second substrate SUB2 and the third substrate SUBS.

The detection electrode Rx and the second connection line Lb are disposed on the lower surface 3B. Also, the drive electrode Tx not illustrated is disposed on the lower surface 3B, and is formed integrally with the second connection line Lb. Each of the second connection lines Lb is arranged between adjacent detection electrodes Rx, and is spaced apart from these detection electrodes Rx. The detection electrode Rx and the second connection line Lb are covered with an insulating film 300. The first connection line La is disposed between the insulating film 300 and the basement 20, and is in contact with the detection electrodes Rx adjacent to each other with the second connection line Lb interposed between them. An overcoat layer OC covers the insulating film 300 and the first connection line La. The present embodiment discloses a mutual-capacitive sensor device 100 which performs the sensing by using the detection electrodes Rx and the drive electrodes Tx. However, the sensor device 100 may be a sensor of the other methods, such as a self-capacitive sensor which performs the sensing by using the capacitance of the detection electrode itself. Also, the sensor device 100 may use any one of a resistance film mode, an optical mode, and an ultrasonic mode, not limited to a capacitive mode.

Note that also in the example shown in FIG. 18, the basement 20 and the adhesive layer 40 may be omitted. In this case, the common electrode CE is in contact with the overcoat layer OC.

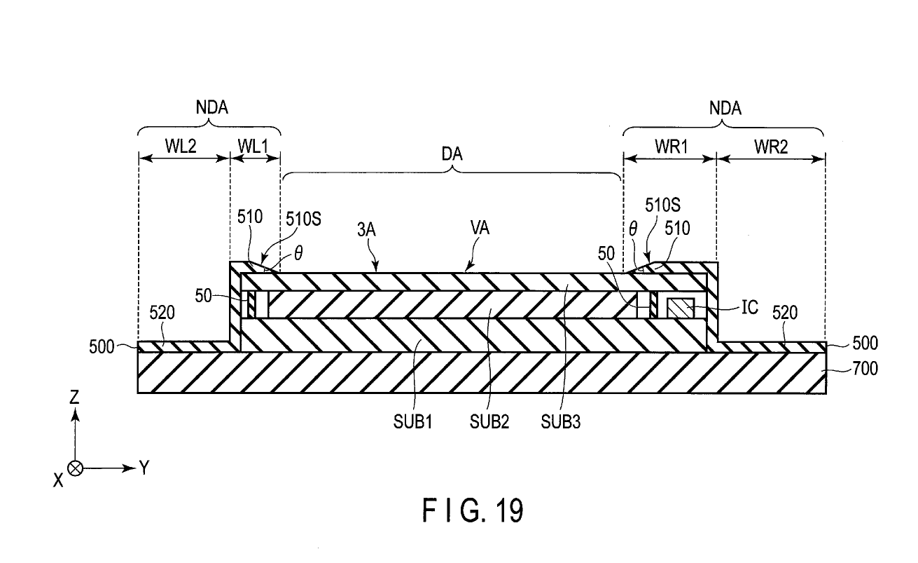

FIG. 19 is a cross-sectional view showing a third configuration example of the display device DSP of the present embodiment. The display device DSP comprises, for example, a frame 500, and a frame 700, in addition to the first substrate SUB1, the second substrate SUB2, and the third substrate SUB3 shown in FIG. 18. The third substrate SUB3 includes an upper surface 3A. The upper surface 3A includes a display surface VA overlapping the display portion DA.

The frame 500 surrounds the display portion DA, and is located in the non-display portion NDA. The frame 500 includes a first area 510 located above the display surface VA, and a second area 520 located below the display surface VA. On the right side of the illustrated cross section, a width WR1 of the first area 510 is less than a width WR2 of the second area 520. Similarly, on the left side of the illustrated cross section, a width WL1 of the first area 510 is less than a width WL2 of the second area 520.

The first area 510 is in contact with the upper surface 3A. The first area 510 includes an inclined surface 510S of a forward tapered shape in which an angle θ formed with respect to the upper surface 3A is an acute angle.

Also, the frame 500 has a reflectance which is less than or equal to a reflectance of a white image displayed on the display surface VA. For example, as the color of the frame 500, off-white, gray, black, etc., are suitable.

The first substrate SUB1, the second substrate SUB2, and the third substrate SUB3 are located between the frame 700 and the first area 510. The second area 520 is fixed to the frame 700. A drive circuit IC is located on the first substrate SUB1, and the sealant 50 is located between the second substrate SUB2 and the drive circuit IC.

According to such a third configuration example, of the frame 500, since a width of the first area 510 located above the display surface VA is less than a width of the second area 520 located below the display surface VA, the display surface VA can be visually recognized as being closer to the observer than the frame 500. Further, since the reflectance of the frame 500 is less than or equal to the reflectance of the white image of the display surface VA, brightness of the display surface VA can be emphasized. Further, since the first area 510 has the inclined surface 510S of a forward tapered shape, even if the display device DSP is observed obliquely, a blind spot, which is caused by the frame 500, is hard to be produced on the display surface VA. Accordingly, visibility of the display surface VA can be improved.

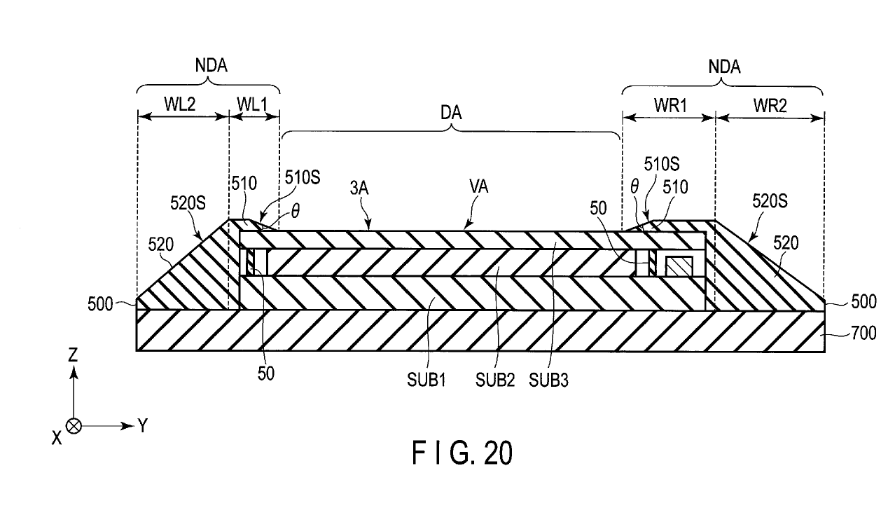

FIG. 20 is a cross-sectional view showing a modification of the third configuration example. The modification shown in FIG. 20 is different from the third configuration example shown in FIG. 19 in that the second area 520 includes an inclined surface 520S. The inclined surface 520S is inclined such that it is lowered toward the outside from the first area 510.

Also in this modification, advantages similar to those described above can be obtained.

As explained above, according to the present embodiment, a display device capable of improving the reliability can be provided.

In the present embodiment described above, the insulating film 13 corresponds to an organic insulating film, the upper surface 13A corresponds to a first upper surface, and the end portion 13S corresponds to a first end portion.

The insulating films 11 and 12 correspond to one or more insulators located between the basement 10 and the insulating film 13, the upper surfaces 11A and 12A correspond to second upper surfaces, and the end portion 11S and 12S correspond to second end portions.

The basement 10 corresponds to a first basement, the upper surface 10A corresponds to a third upper surface, and the end portion 10S corresponds to a third end portion.

The insulating film 14 corresponds to an inorganic insulating film, and the end portion 14S corresponds to a fourth end portion.

The basement 20 corresponds to a second basement, and the end portion 20S corresponds to a fifth end portion.

The third substrate SUBS corresponds to a protective substrate, and the end portion 3S corresponds to a sixth end portion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display portion;
a non-display portion defining the display portion;
a first basement provided over the display portion and the non-display portion;
an organic insulating film provided over the display portion and the non-display portion above the first basement, and the organic insulating film including a first upper surface and a first end portion;
an inorganic insulating film provided from the first upper surface to the first basement and covering the first upper surface and the first end portion in the non-display portion;
a plurality of pixel electrodes provided in the display portion;
a common electrode provided to be opposed to the plurality of the pixel electrodes;
an electrophoretic element provided between the pixel electrodes and the common electrode; and
a sealant provided on the inorganic insulating film in the non-display portion, and sealing at least the electrophoretic element.

2. The display device of claim 1, further comprising one or more insulators provided between the first basement and the organic insulating film, wherein the insulators are formed of inorganic insulating materials.

3. The display device of claim 2, wherein:
the insulators include a second upper surface and a second end portion outside the first end portion; and
the inorganic insulating film covering the first upper surface and the first end portion extends to the second upper surface in the non-display portion.

4. The display device of claim 3, wherein:
the first basement includes a third end portion;
the inorganic insulating film includes a fourth end portion; and
the second end portion is located above the third end portion, and the fourth end portion is located above the second end portion.

5. The display device of claim 3, wherein:
the first basement includes a third upper surface and a third end portion outside the second end portion; and
the inorganic insulating film covering the second end portion extends to the third upper surface.

6. The display device of claim 5, wherein:
the inorganic insulating film includes a fourth end portion; and
the fourth end portion is located above the third end portion.

7. The display device of claim 2, wherein:
the insulator includes a second end portion;
the first end portion is located above the second end portion;
the first basement includes a third upper surface and a third end portion outside the second end portion; and
the inorganic insulating film covering the first upper surface, the first end portion, and the second end portion, extends to the third upper surface in the non-display portion.

8. The display device of claim 7, wherein:
the inorganic insulating film includes a fourth end portion; and
the fourth end portion is located above the third end portion.

9. The display device of claim 2, wherein:
the inorganic insulating film includes a fourth end portion; and
the first end portion is entirely located on an inner side relative to the fourth end portion in planar view.

10. The display device of claim 9, wherein:
the first basement includes a third end portion; and
the fourth end portion is flush with the third end portion, or is located on an inner side relative to the third end portion in planar view.

11. The display device of claim 1, further comprising an adhesive layer provided between the pixel electrode and the electrophoretic element; and
the sealant seals the electrophoretic element and the adhesive layer.

12. The display device of claim 11, further comprising a second basement located above the common electrode and including a fifth end portion, wherein
the sealant extends to the fifth end portion.

13. The display device of claim 1, further comprising one or more walls opposed to the organic insulating film through space, wherein
the sealant is provided from the organic insulating film to the walls and is filled in the space.

14. The display device of claim 1, further comprising:
a second basement located above the common electrode and including a fifth end portion; and
a protective substrate opposed to the common electrode through the second basement, wherein
the protective substrate includes a lower surface opposed to the inorganic insulating film in the non-display portion and a sixth end portion, and
the sealant is in contact with the lower surface, and includes an outer end portion which does not protrude outside the sixth end portion.

15. The display device of claim 14, further comprising a sensor device including a detection electrode and a drive electrode, wherein
the sensor device is provided between the protective substrate and the common electrode.

16. The display device of claim 1, further comprising a frame surrounding the display portion, wherein
the frame includes a first area located above a display surface of the display portion, and a second area located below the display surface, and
a width of the first area is less than a width of the second area.

17. The display device of claim 16, wherein a reflectance of the frame is less than or equal to a reflectance of a white image displayed on the display surface.

18. The display device of claim 1, wherein the inorganic insulating film is provided between the organic insulating film and the pixel electrode in the display portion.

19. The display device of claim 1, further comprising a conductive layer provided between the organic insulating film and the inorganic insulating film in the display portion, wherein
the pixel electrode overlaps the conductive layer via the inorganic insulating film.
